(19) United States
(12) Patent Application Publication
(10) Pub. No.: US 2005/0257877 A1
(43) Pub. Date: Nov. 24, 2005

(54) Bonded assemblies

(76) Inventor: David H. Stark, Evergreen, CO (US)

Correspondence Address: HOWISON & ARNOTT, L.L.P, P.O. BOX 741715, DALLAS, TX, 75374-1715, US

(21) Appl. No.: 11/109,993

(22) Filed: Apr. 19, 2005

Related U.S. Application Data
(60) Provisional application No. 60/563,499, filed on Apr. 19, 2004.
(60) Provisional application No. 60/635,104, filed on Dec. 10, 2004.

(51) Int. Cl. B32B 31/00

(52) U.S. Cl. 156/182; 156/288

(57) ABSTRACT

A process for manufacturing bonded assemblies comprises providing a first layer formed of a substrate material that is one of an electrical conductor, a semiconductor and an electrical insulator. A second layer of an electrically insulating material is formed on the top surface of the first layer, the second layer having a top surface. A third layer formed of a semiconductor material is disposed near the top surface of the second layer. The third layer is pressed against the top surface of the second layer with sufficient force to produce a predetermined contact pressure along a junction region between the second and third layers. The junction region is heated to produce a predetermined initial temperature in the junction region. The predetermined contact pressure and an elevated temperature are maintained in the junction region until a diffusion bond forms between the second and third layers.

### CROSS REFERENCE TO RELATED APPLICATIONS

The current application claims the benefit of U.S. Provisional Application No. 60/563,499 titled “BONDED ASSEMBLIES” filed Apr. 19, 2004, and of U.S. Provisional Application No. 60/635,104 titled “BONDED ASSEMBLIES” filed Dec. 10, 2004.

### TECHNICAL FIELD OF THE INVENTION

The current invention relates to bonded assemblies formed by laminating or bonding together materials having different electrical properties, semiconducting properties, thermal properties, chemical properties and/or other physical properties. In particular, it relates to bonded assemblies having two or more discrete layers of such materials, and methods for fabricating such assemblies. Applications include semiconductor wafer-on-insulator (SWOI) components, and methods for fabricating such components, using semiconductor materials including silicon (Si) or gallium-arsenide (GaAs), and using insulator materials including glass, silicon oxides or oxides of gallium arsenide.

### BACKGROUND OF THE INVENTION

Assemblies comprising multiple layers of dissimilar materials are known for use in many applications. One such assembly of considerable interest to the semiconductor industry is the semiconductor wafer-on-insulator (SWOI) assembly used in the manufacturing of semiconductor devices. SWOI assemblies are known having two and three layers. A two-layer SWOI assembly typically has a layer of semiconductor material joined to a layer of electrically insulating material. A three-layer SWOI assembly typically has a layer of electrically insulating material sandwiched between a thin layer of semiconductor material on one side and a semiconductor substrate layer on the other side.

One important type of SWOI assembly is known as silicon-on-insulator (SOI). Typically used as a substrate in the production of semiconductor devices, SOI assemblies are three-layer assemblies having a thin surface layer of silicon semiconductor that is electrically isolated from the main semiconductor substrate by a thin electrically insulating layer. When a silicon surface layer is used, the insulator layer is typically an oxide of silicon (e.g., silicon dioxide) and the main semiconductor substrate layer is typically silicon. Using SOI substrate assemblies rather than traditional bulk silicon techniques can produce faster, lower-power consuming semiconductor devices, because the insulator layer in a SOI assembly helps reduce the amount of electrical charge that the device's transistors have to move during switching operations.

To date, however, the production of SOI assemblies has been based primarily on the use of high-temperature thermal growth and/or deposition techniques to form the insulator layer on the top of the substrate layer and/or the bottom of the upper semiconductor wafer layer. These process-intensive techniques are relatively expensive, thus SOI-based devices have been more expensive to produce that conventional silicon devices. This has limited the use of SOI-based devices to high-end applications that can justify the incremental costs for the performance gain. A need therefore exists, for SOI assemblies which can be produced at lower cost than conventional techniques.

In addition, the high-temperature processes used in producing conventional SOI assemblies may limit the types of materials (and/or their treatment or doping) that can be used in the various layers. A need therefore exists, for new processes for producing bonded assemblies, which processes require lower process temperatures than those associated with current processes.

### SUMMARY OF THE INVENTION

The present invention disclosed herein comprises, in one aspect thereof, a process for manufacturing bonded assemblies. The process comprises providing a first layer formed of a substrate material that is one of an electrical conductor, a semiconductor and an electrical insulator. The first layer has a top surface and an initial thickness. A second layer of an electrically insulating material is formed on the top surface of the first layer, the second layer having a top surface and an initial thickness after forming. A third layer formed of a semiconductor material is provided disposed near the top surface of the second layer, the third layer having a top layer and an initial thickness. The third layer is pressed against the top surface of the second layer with sufficient force to produce a predetermined contact pressure along a junction region between the second and third layers. The junction region is heated to produce a predetermined initial temperature in the junction region. The predetermined contact pressure and an elevated temperature are maintained in the junction region until a diffusion bond forms between the second and third layers.

The present invention disclosed herein comprises, in another aspect thereof, a process for manufacturing bonded assemblies. A first lamina is provided that is formed of a substrate material that is one of an electrical conductor, a semiconductor and an electrical insulator. A second lamina formed of an electrically insulating material is superposed on top of the first lamina to define a first junction region where the first and second laminae contact one another. A third lamina formed of a semiconductor material is superposed on top of the second lamina to define a second junction region where the second and third laminae contact one another. The first and second laminae are pressed together with sufficient force to produce a first predetermined contact pressure between the first and second laminae along the first junction region. The first junction region is heated to produce a first predetermined temperature along the first junction region. The first predetermined contact pressure and the first predetermined temperature are maintained until a first diffusion bond is formed between the first and second laminae all along the first junction region. The second and third laminae are pressed together with sufficient force to produce a second predetermined contact pressure between the second and third laminae along the second junction region. The second junction region is heated to produce a second predetermined temperature along the second junction region. The second predetermined contact pressure and the second predetermined temperature are maintained until a second diffusion bond is formed between the second and third laminae all along the second junction region. The first and second lamina may be bonded together before, after, or simultaneously with the bonding together of the second and third lamina.

The present invention disclosed herein comprises, in another aspect thereof, a process for manufacturing bonded assemblies having two layers or lamina. A first layer is provided formed of an electrically insulating material. A second layer formed of a semiconductor material is superposed on top of the first layer to define a junction region where the first and second layers contact one another. The first and second layers are pressed together with sufficient force to produce a predetermined contact pressure between the first and second layers along the junction region. The junction region is heated to produce a predetermined temperature along the junction region. The predetermined contact pressure and the predetermined temperature are maintained until a diffusion bond is formed between the first and second layers along the junction region.

The present invention disclosed herein comprises, in a further aspect thereof, a process for manufacturing bonded assemblies using interlayers. A first lamina is provided formed of a substrate material that is one of an electrical conductor, a semiconductor and an electrical insulator. A second lamina is provided formed of an electrically insulating material disposed near the first lamina. A first interlayer is interposed between the first and second laminae. The first and second laminae are pressed against the first interlayer with sufficient force to produce a first predetermined contact pressure between the first lamina and the first interlayer and between the second lamina and the first interlayer. The first interlayer is heated to produce a first predetermined temperature in a region surrounding the first interlayer. The first predetermined contact pressure and an elevated temperature are maintained until diffusion bonds are formed between the first lamina and the second lamina. A third lamina is provided formed of a semiconductor material and disposed near the insulator lamina. A second interlayer is interposed between the second and third laminae. The second and third laminae are pressed against the second interlayer with sufficient force to produce a second predetermined contact pressure between the second lamina and the second interlayer and between the third lamina and the second interlayer. The second interlayer is heated to produce a second predetermined temperature in a region surrounding the second interlayer. The second predetermined contact pressure and an elevated temperature are maintained until diffusion bonds are formed between the second lamina and the third lamina. The first and second lamina may be bonded before, after, or simultaneously with the bonding of the second and third lamina.

The present invention disclosed herein comprises, in yet another aspect thereof, a bonded assembly for use in the fabrication of semiconductor, Micro-Electro-Mechanical Systems (MEMS) and other electronics, photo-electronics and electro-optics devices, comprising a mechanical substrate, insulator layer and a silicon, GaAs or other semiconductor layer. The assembly's layers are hermetically bonded without non-hermetic adhesives to form a continuous hermetic joint therebetween.

The present invention disclosed herein comprises, in a further aspect thereof, a bonded assembly for use in the fabrication of semiconductor, Micro-Electro-Mechanical Systems (MEMS) and other electronics, photo-electronics and electro-optics devices, comprising a silicon, GaAs or other semiconductor layer and mechanical substrate which may also be an electrical insulating layer. The assembly's two layers are hermetically bonded without non-hermetic adhesives to form a continuous hermetic joint therebetween.

The present invention disclosed and claimed herein comprises, in yet another aspect thereof, a method for producing bonded assemblies, including the following steps: Providing an insulator material layer having an upper sealing surface and a lower sealing surface, the upper sealing surface being disposed on the upper side of the insulator material layer, and the lower sealing surface being disposed on the lower side of the insulator material layer. Providing a semiconductor material layer and also a substrate layer that is composed of one of an electrical conductor material, semiconductor material or insulator material. Positioning the first semiconductor layer against the upper sealing surface of the insulator, the overlap between them defining an upper junction (i.e. bond), and positioning the substrate layer against the lower sealing surface of the insulator, the overlap between them defining a lower junction. Pressing the semiconductor material layer and the substrate material layer against the layer of insulating material with sufficient force to produce a predetermined contact pressure throughout the upper and lower junctions. Heating the junctions to produce a predetermined temperature throughout the junctions. Maintaining the predetermined contact pressure and the predetermined temperature until a diffusion bond is formed between the semiconductor material layer, the layer of insulating material and the substrate material layer throughout the junction regions.

The present invention disclosed and claimed herein comprises, in still another aspect thereof, a bonded assembly comprising a first layer of a mechanical substrate made of one of an electrical insulator, conductor or semiconductor, and a second layer composed of a semiconductor composed primarily of one of silicon, GaAs or other material. The sealing surface of the first layer is disposed against the sealing surface of the second layer. The first and second layers are hermetically bonded to one another along the sealing surfaces without non-hermetic adhesives to form a continuous hermetic joint therebetween.

### BRIEF DESCRIPTION OF THE DRAWINGS

FIG. 1a is an exploded view of the three components of a bonded assembly prior to joining in accordance with one embodiment of the current invention;

FIG. 1b shows the bonded assembly of FIG. 1a after joining;

FIG. 2a is an exploded view of the components of a bonded assembly including interlayers prior to joining in accordance with yet another embodiment of the current invention;

FIG. 2b shows the bonded assembly of FIG. 2a after joining;

FIGS. 3a, 3b, 3c and 3d, illustrate a bonded assembly in accordance with yet another embodiment of the current invention; specifically:

FIG. 3a is an exploded view showing three components of the bonded assembly prior to joining;

FIG. 3b is an exploded view after the first joining step;

FIG. 3c is an exploded view after the layer thinning step; and

FIG. 3d shows the bonded assembly after joining;

FIG. 4 illustrates one apparatus for fixturing multiple sets of assemblies for simultaneous bonding;

FIGS. 5a, 5b and 5c, illustrate fixtures for aligning and compressing the assemblies during diffusion bonding; specifically:

FIG. 5a illustrates an empty fixture and clamps;

FIG. 5b is a cross-sectional view of the fixture of FIG. 5a with the components of an assembly positioned therein for bonding;

FIG. 5c is a cross-sectional view of an alternative fixture designed to produce more axial pressure on the assembly;

FIG. 6 is a perspective view of a silicon-on-insulator bonded wafer assembly in accordance with another embodiment;

FIGS. 7a-7f, illustrate a semiconductor wafer-on-insulator bonded assembly and method in accordance with yet another embodiment; specifically:

FIG. 7a is a perspective view of the initial substrate layer of the assembly;

FIG. 7b is a perspective view of the initial insulator layer applied to the substrate layer;

FIG. 7c is a perspective view of the insulator layer and substrate layer subassembly after thinning;

FIG. 7d is a perspective view of the semiconductor top layer prior to bonding to the insulator layer and substrate layer subassembly;

FIG. 7e is a perspective view of the entire assembly after bonding;

FIG. 7f is a perspective view of the bonded assembly after final thinning operations;

FIG. 8 is a simplified flow diagram of a method for producing bonded assemblies in accordance with another embodiment;

FIGS. 9a and 9b are a flow diagram of a method for producing bonded assemblies in accordance with yet another embodiment; and

FIG. 10 is a flow diagram of a method for producing bonded assemblies in accordance with still another embodiment.

### DETAILED DESCRIPTION OF THE INVENTION

The current invention is described below in greater detail with reference to certain preferred embodiments illustrated in the accompanying drawings.

In one embodiment, the joining of two or more layers of material is performed to create bonded layered assemblies. These bonded layered assemblies may be semiconductor wafer-on-insulator (SWOI) assemblies including silicon-on-insulator (SOI) assemblies. Preferably, the joints between the layers forming the bonded assemblies will be very thin, strong, permanent and hermetic (i.e., maintaining gas-tight integrity indefinitely), and free of material voids. Such joints better resist delamination and are generally stronger than non-hermetic joints. Present methods used for the fabrication of layered assemblies such as SWOI and SOI assemblies are costly, require complex capital equipment and are time consuming. To produce layered assemblies such as SWOI and SOI assemblies in a more cost-effective manner, bonded assemblies having a true hermetic permanent joint/bond between the layers are made using diffusion bonding, as further explained herein.

Referring now to FIGS. 1a and 1b, there is illustrated a bonded assembly in accordance with one embodiment. FIG. 1a is an exploded view of the components prior to assembly, while FIG. 1b shows the completed assembly. It will be appreciated that the thicknesses of the layers shown in all of the FIGURES may be exaggerated for purposes of illustration, and the relative thicknesses of the layers may not be shown to scale. The assembly 100 includes a first layer, or lamina, 104 of a first material, a second layer, or lamina, 102 of a second material and a substrate layer, or lamina, 106 of a third material. It will be understood that the terms “layer” and “lamina” are used interchangeably herein. The first layer 104 and the substrate layer 106 may be formed of the same material or different materials. The layers will typically be of approximately the same size and shape (i.e., when viewed from above), but may be of significantly different thicknesses.

Prior to assembly and bonding, some or all of the layers 104, 102 and 106 may require pre-bonding preparation steps. Such pre-bonding preparation operations may include the removal of material from one or both sides of the layer, e.g., grinding and/or polishing to achieve predetermined values for flatness, parallelism, thickness and/or surface finish. Pre-bonding preparation operations may also include the application of surface treatments and/or coatings to one or both sides of the layer. Such treatments and/or coatings may be applied by direct chemical deposition, chemical vapor deposition (CVD), plasma vapor deposition (PVD), or by growing the surface treatment or coating onto the relevant surface. Other treatments and/or coating methods that may be employed include dipping in a solution (immersion), spray coating and spin coating. In some embodiments, surface treatments and/or coatings may be used as an interlayer (as further described below) to facilitate bonding between the various layers of the bonded assembly. Still further pre-bonding preparation operations may include chemical, vapor or plasma treatment of one or both surfaces of the layer. Yet other pre-bonding preparation operations may include grinding and/or polishing the previously applied surface treatments and/or coatings.

After all pre-bonding preparation steps have been performed, the various component layers are assembled, aligned, and fixtured as required for bonding. Typically, the first layer 104 is disposed over the upper junction surface 103 of the second layer 102, and the substrate layer 106 is disposed under the lower junction surface 105 of the second layer. The first and substrate layers 104 and 106 are each bonded to the second layer 102 across the overlapping junction surfaces 103 and 105 to form continuous hermetic joints therebetween. Obviously, this hermetic joint is formed without the use of non-hermetic adhesives such as rubber, glues, epoxies and resins.

The preferred process for hermetically joining the component layers of the bonded assembly is so-called diffusion bonding. Diffusion bonding is a solid-state joining process capable of forming high-quality joints between a wide range of combinations of similar or dissimilar materials, including metals, semiconductors, ceramics, glasses and other non-metals, through the action of atomic diffusion across an interface. Typically, diffusion bonding involves holding surface-prepared components together under load (i.e., bonding pressure) at an elevated temperature for a specified length of time. The specific values of the diffusion bonding parameters (i.e., pressure, temperature and time) may vary according to the kind of materials to be joined, their surface finish, and the expected service conditions. Generally speaking, however, the bonding pressures used are typically below those that will cause macrodeformation of the parent materials, and the temperature used is typically less than 80% of the parent material's melting temperature (in °K). In many cases, diffusion bonding is performed in a protective atmosphere or vacuum, however, this is not always required.

The heat for bonding may be provided by radiant, induction, direct or indirect resistance heating. Load pressure can typically be applied uniaxially or isostatically. When uniaxial loading is used, relatively low loading pressures, e.g., within the range from about 500 psi to about 1500 psi, may be required to prevent macrodeformation of the parts (i.e., no more than a few percent). In such cases, and in other circumstances where low bonding pressures must be used, a very good surface finish on the mating (i.e., junction) surfaces may be required for bonding. In a preferred embodiment, a surface finish of better than about 0.4 micron RA is provided on the mating surfaces. When hot isostatic pressing is used, relatively higher loading pressures may be used, e.g., up to the range from about 14,500 psi to 29,000 psi. In such cases, and in other circumstances where higher bonding pressures may be used, a lesser surface finish on the mating (i.e., junction) surfaces may be acceptable for bonding. In another embodiment, a surface finish of better than about 0.8 micron RA is provided on the mating surfaces.

In some embodiments, a variation of diffusion bonding known as Transient Liquid Phase diffusion bonding (i.e., “TLP diffusion bonding”) may be used for some or all of the bonds required in the bonded assemblies. In TLP diffusion bonding, solid state diffusional processes caused by the elevated pressure (i.e., load) and heat of the bonding process lead to a change in material composition (e.g., a new material phase) at the bond interface, and the initial bonding temperature is selected as the temperature at which this new phase melts. Alternatively, an interlayer of a material having a lower melting temperature than the parent material may be placed between the layers to be joined, and the initial bonding temperature is selected as the temperature at which the interlayer melts. Thus, a thin layer of liquid spreads along the interface to form a transient joint at a lower temperature than the melting point of either of the parent materials. The initial bonding temperature is then reduced slightly to a secondary temperature allowing solidification of the melt. This elevated temperature (i.e., the secondary temperature) and the elevated pressure (i.e., load) are maintained until the now-solidified transient joint material diffuses into the parent materials by solid-state diffusion, thereby forming a diffusion bond at the junction between the parent materials.

It will be appreciated that the terms “diffusion bonding” and “thermal compression bonding” (and its abbreviation “TC bonding”) are often used interchangeably throughout this application and in the art. The term “diffusion bonding” is preferred by metallurgists, while the term “thermal compression bonding” is preferred in many industries (e.g., semiconductor manufacturing) to avoid possible confusion with other types of “diffusion” processes used in semiconductor manufacturing. Regardless of which term is used, as previously discussed, diffusion bonding refers to the family of bonding methods using heat, pressure, atmospheres and time alone to create a bond between mating surfaces at a temperature below the normal fusing temperature of either mating surface. In other words, neither mating surface is intentionally melted, and no chemical adhesives are used.

A very important distinction of diffusion bonding (as compared to other bonding processes) is the high quality of the resulting joints. It is the only process known to preserve the properties inherent in monolithic materials, in both metal-to-metal and nonmetal joints. With properly selected process variables (temperature, pressing load and time), the material at and adjacent to the joint will have the same strength and plasticity as the bulk of the parent material(s). When the process is conducted in vacuum, the mating surfaces are not only protected against further contamination, such as oxidation, but are cleaned, because the oxides present dissociate, sublime, or dissolve and diffuse into the bulk of the material. A diffusion-bonded joint is free from incomplete bonding, oxide inclusions, cold and hot cracks, voids, warpage, loss of alloying elements, etc. Since the bonding surfaces are brought into intimate contact with one another, there is no need for fluxes, electrodes, solders, filler materials, etc. Diffusion-bonded parts usually retain the original values of ultimate tensile strength, angle of bend, impact toughness, vacuum tightness, etc.

As described above, in some cases the diffusion bonding process for joining component layers may be done in a vacuum or partial vacuum (an evacuated chamber), in a vacuum with the intentional addition of one or more gases to increase or accelerate reduction of oxides (such as, but not limited to hydrogen), or in a vacuum with the addition of one or more inert gases (such as, but not limited to argon). In other cases, the diffusion bonding maybe done in a special atmosphere to increase oxidation of the surface of one or more of the component layers. This special atmosphere may be a negative pressure, ambient pressure or a positive pressure, with one or more gasses added to promote (instead of reduce) the oxidation of one or more of the assembly's component surfaces. The added gasses for promoting oxidation include, but are not limited to, oxygen.

In some instances, the joint resulting from the diffusion bonding process will include chemical bonding between one or more of the materials. In some cases, this chemical bonding may be in addition to significant atomic-diffusion type bonding between the materials. In other instances, the resulting joint will be primarily a chemical bond with little atomic-diffusion type bonding.

After diffusion bonding, post-bonding operations may be performed on the assembly. For example, further material removal, grinding or polishing of the exposed surfaces of the assembly may be performed. Also, heat treatments such as annealing may be performed on the entire assembly, or on selected surfaces of the assembly. Still further post-bonding operations may include the application of surface treatments and/or coatings to exposed surfaces of the assembly.

Referring still to FIGS. 1a and 1b, in one embodiment the bonded assembly 100 is a two-layer semiconductor wafer-on-insulator (SWOI) assembly including only layers 104 and 102. The first layer 104 may be formed of a semiconductor material such as silicon or GaAs, and the second layer 102 may be formed of an electrically insulating material such as an oxide of silicon or glass. The layers 104 and 102 are hermetically joined to one another using diffusion bonding as follows: The first layer 104 is positioned on top of the second layer 102. The layers 104 and 102 are pressed together with sufficient force to produce a predetermined contact pressure between the first and second layers along the first junction region 103, and one or both layers is heated to produce a predetermined temperature along the first junction region. The previous two steps may be conducted simultaneously or in either order, and further may be conducted in a vacuum or special atmosphere. The predetermined contact pressure and the an elevated temperature are maintained until a diffusion bond is formed between the first and second layers 104 and 102 all along the first junction region 103.

When using solid-state diffusion bonding, the predetermined (i.e., initial) bonding temperature at a junction is typically the same as the elevated (i.e., secondary) bonding temperature, i.e., the temperature required for solid-state atomic-level diffusion to take place at the junction. When using TLP diffusion bonding, the predetermined bonding temperature is typically a temperature at which the junction's transient phase or interlayer melts, and the elevated temperature is typically a temperature low enough for the melted joint to re-solidify, but high enough to allow solid-state atomic-level diffusion to take place at the junction.

In another embodiment, the bonded assembly 100 is a three-layer SWOI assembly including layers 104, 102 and 106. The first layer 104 may be formed of a semiconductor material such as silicon or GaAs, the second layer 102 may be formed of an electrically insulating material such as an oxide of silicon or glass, and the substrate layer 106 is a mechanical substrate. The substrate 106 may be an electrical insulator (e.g., glass, ceramic, plastic), a conductor (e.g., metal or metal alloy) or a semiconductor (e.g., silicon or GaAs). At least two of the layers 104, 102 and 106 are hermetically joined to one another using diffusion bonding as previously described. In some embodiments, all three layers 104, 102 and 106 are hermetically joined to one another using diffusion bonding as follows: The first layer 104 is positioned on top of the second layer 102. The layers 104 and 102 are pressed together with sufficient force to produce a first predetermined contact pressure between the first and second layers along the first junction region 103, and one or both layers is heated to produce a first predetermined temperature along the first junction region. The previous two steps may be conducted simultaneously or in either order, and further may be conducted in a vacuum or special atmosphere. The first predetermined contact pressure and a first elevated temperature are maintained until a diffusion bond is formed between the first and second layers 104 and 102 all along the first junction region 103. Further, the second layer 102 is positioned on top of the substrate layer 106. The layers 102 and 106 are pressed together with sufficient force to produce a second predetermined contact pressure between the second and substrate layers along the second junction region 105, and one or both layers is heated to produce a second predetermined temperature along the second junction region. The previous two steps may be conducted simultaneously or in either order, and further may be conducted in a vacuum or special atmosphere. The second predetermined contact pressure and a second elevated temperature are maintained until a diffusion bond is formed between the second and substrate layers 102 and 106 all along the first junction region 105. The bonding of the first layer 104 to the second layer 102, and the bonding of the second layer to the substrate layer 106 may be conducted simultaneously or in either order.

In yet another embodiment, the bonded assembly 100 is a three-layer silicon-on-insulator (SOI) assembly including layers 104, 102 and 106. The first layer 104 is a thin layer of silicon, the second layer 102 may be formed of an electrically insulating material such as an oxide of silicon or glass, and the substrate layer 106 may be formed of a semiconductor material such as silicon or GaAs, which may be the same as, or different from, the material of the first layer. In a preferred embodiment, the substrate layer 106 is also formed of silicon. At least two of the layers 104, 102 and 106 are hermetically joined to one another using diffusion bonding as previously described. In some embodiments, all three layers 104, 102 and 106 are hermetically joined to one another using diffusion bonding as previously described.

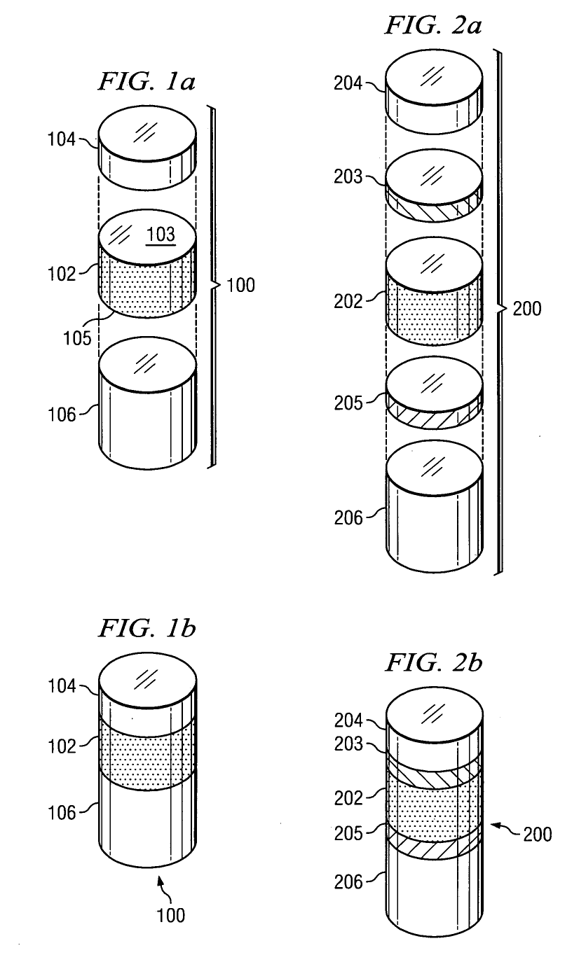

Referring now to FIGS. 2a and 2b, there is illustrated a bonded SWOI assembly in accordance with another embodiment including interlayers to promote joining by diffusion bonding. FIG. 2a is an exploded view of the components prior to fixturing, while FIG. 2b shows the assembled components of the assembly. The assembly 200 of this embodiment includes a single insulator layer 202 positioned between a semiconductor layer 204 and a substrate layer 206, similar to the configuration of FIG. 1a. In this case, however, an interlayer 203 is provided between the insulator layer 202 and the semiconductor layer 204, and an interlayer 205 is provided between the insulator layer 202 and the substrate layer 206. The interlayers 203 and 205 in this embodiment may take the form of solder glass preforms having a configuration selected to match the mating areas of the semiconductor layer 204, the insulator layer 202 and the substrate layer 206.

Prior to assembly and bonding, some or all of the layers 204, 202 and 206, and some or all of the interlayers 203 and 205 may require pre-bonding preparation steps. Such pre-bonding preparation operations may include the removal of material and the application of surface treatments and/or coatings as previously described. In some embodiments, the interlayers 203 or 205 may be provided as surface treatments and/or coatings formed on the layers 204, 202 or 206 rather than as discrete preforms.

Referring now to FIG. 2b, to bond the assembly 200, the semiconductor layer 204, insulator layer 202, interlayers 203 and 205 and substrate layer 206 are placed in a fixture or mechanical apparatus (not shown) that aligns the layers and provides the predetermined pressure required for diffusion bonding between the mating areas of the respective components. In some cases, the fixture may serve only to align the components during bonding, while the elevated bonding pressure is applied from a mechanical apparatus such as a ram. In other cases, however, the fixture may be designed to constrain the expansion of the stacked components during heating (i.e., along the stacking axis), whereby the thermal expansion of the assembly components toward the fixture, and of the fixture itself toward the components, will “self-generate” some or all of the pressure necessary for diffusion bonding between the components as the temperature increases. In other embodiments, hot isostatic pressing (HIP) (as further described herein) may be used to load the assembly for bonding rather than conventional fixturing.

The assembled (but not yet bonded) components of the assembly 200 are then heated until the diffusion bonding pressure/temperature conditions are reached, and these conditions are maintained until a first diffusion bond is formed between the substrate 204 and the interlayer 203, a second diffusion bond is formed between the interlayer 203 and the insulator layer 202, a third diffusion bond is formed between the insulator layer 202 and the interlayer 205, and a fourth diffusion bond is formed between the interlayer 205 and the substrate layer 206. It will be understood that any of the bonds, such as the bond between the semiconductor layer 204 and the interlayer 203 may actually occur before, after or simultaneously with and other bonds between adjacent layers. As previously explained, it will also be understood that the order of applying heat and pressure to form the diffusion bond is not believed to be significant, i.e., whether the pre-determined pressure is applied, and then the heat is applied or whether the heat is applied and then the predetermined pressure is applied, or whether both heat and pressure are increased simultaneously is not believed to be significant, rather the diffusion bonding will occur when the pre-selected pressure and temperature are present in the bond region for a sufficient amount of time. After the diffusion bonds are formed, the completed assembly 200 will typically resemble the assembly of FIG. 1b, i.e., the interlayers may no longer be visible after bonding. However, in some cases one or both interlayers will remain visible after bonding.

In embodiments using interlayers, materials other than glass may be used for the interlayer material. The interlayers may comprise: a glass material; a solder-glass material such as solder-glass in tape form, solder-glass in layer form, solder-glass in paste form (the paste would be applied by dispensing or by screen-printing), solder-glass in powder form (the glass powder would be mixed with water, alcohol or another solvent and sprayed or otherwise applied onto either of the surfaces to be joined); a metal material; a metal alloy material; a material other than glass, glass-solder, metal or metal alloy, including, but not limited to ceramics, composite materials, woven or mesh materials, woven or mesh materials encapsulated in a composite material; a semiconductor material with or without an oxide surface; or a material composed of a combination of glass and metals and/or metal alloys.

It is important to distinguish the use of diffusion bonding interlayers from the use of conventional solder glass preforms and other processes. For purposes of this application, an interlayer is a material used between mating surfaces to promote the diffusion bonding of the surfaces by allowing the respective mating surfaces to diffusion bond to the interlayer or directly to one another. For example, with the proper interlayer material, the diffusion bonding temperature for the joint between the semiconductor material and interlayer material, and for the joint between the interlayer material and the insulator material, may be substantially below the diffusion bonding temperature of a joint formed directly between the semiconductor material and the insulator layer material. Thus, use of the interlayer allows diffusion bonding together of the two or three assembly component layers at a temperature that is substantially below the diffusion bonding temperature that would be necessary for bonding those two or three component layer materials directly. The joint, which will preferably be hermetic, is still formed by the diffusion bonding process, i.e., none of the parent materials involved melts during the bonding process and the material of the interlayer diffuses atomically into the parent material. This distinguishes diffusion bonding using interlayers from other processes such as the use of solder glass preforms in which the solder material forms only a surface bond between the materials being joined. It is possible to use materials conventionally used for solders, for example, as interlayers for diffusion bonding. However, when used as interlayers they are used for their diffusion bonding properties and not as conventional solders.

The use of interlayers in the production of bonded SWOI assemblies or other devices may provide additional advantages over and above their use as promoting diffusion bonding. These advantages include interlayers that serve as activators for the mating surfaces. Sometimes the interlayer materials will have a higher ductility in comparison to the base materials. The interlayers may also compensate for stresses that arise when the seal involves materials having different coefficients of thermal expansion or other thermal expansion properties. The interlayers may also accelerate the mass transfer or chemical reaction between the layers. Finally, the interlayers may serve as buffers to prevent the formation of undesirable chemical or metallic phases in the joint between components.

Although FIGS. 2a and 2b show the structure of a three-layer (plus interlayers) bonded assembly, there is no limit to the number of component layers, with intermediate bond-enhancing interlayers between pairs of component pieces, that may be used to form a bonded assembly. For example, an assembly could be constructed with four component layers and three interlayer layers, five component layers and four interlayers, etc. Further, the assembly can be constructed of two layers only, e.g., a first semiconductor layer bonded directly to an insulator, or alternatively, to a conductor or other semiconductor.

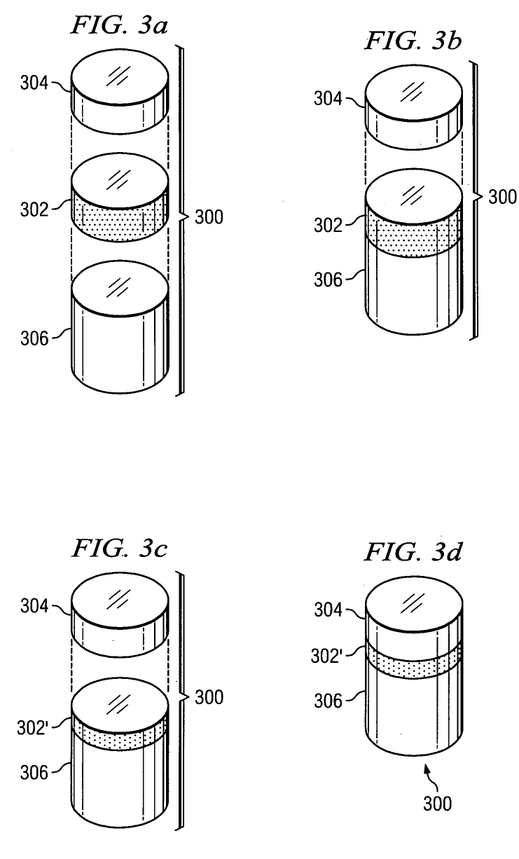

Referring now to FIGS. 3a, 3b, 3c and 3d, there is illustrated a SWOI bonded assembly in accordance with another embodiment which includes thinning of the insulator layer as an intermediate step prior to completing the assembly. FIG. 3a is an exploded view of the components prior to initiating assembly. The bonded assembly 300 is a three-layer SWOI assembly including layers 304, 302 and 306. The top layer 304 may be formed of a semiconductor material such as silicon or GaAs, the second layer 302 may be formed of an electrically insulating material such as an oxide of silicon or glass, and the substrate layer 306 is a mechanical substrate. The substrate 306 may be an electrical insulator (e.g., glass, ceramic, plastic), a conductor (e.g., metal or metal alloy) or a semiconductor (e.g., silicon or GaAs). In a preferred embodiment, both the first layer 304 and the substrate layer 306 are formed of silicon.

In the bonded assembly 300, at least two of the layers 304, 302 and 306 are hermetically joined to one another using diffusion bonding as previously described. In some applications, however, the desired final thickness of the insulator layer may be too small (i.e., too thin) to allow diffusion bonding to another layer without risk of damage. In such cases, an oversized (i.e., overly thick) insulator layer 302 may first be diffusion bonded to the substrate layer 306, as shown in FIG. 3b. Next, as shown in FIG. 3c, the insulator layer, which is now supported by the bonded substrate layer 306, has its thickness reduced to the desired final thickness (now denoted 302′). Next, as shown in FIG. 3d, the top semiconductor layer 304 is diffusion bonded to the previously thinned insulator layer 302′ to complete the assembly.

It will be appreciated that the components of the bonded assembly 300 may require pre-bonding preparation steps and/or post-bonding operations as previously described. It will further be appreciated that in some embodiments, interlayers (not shown) may be used at the junctions between the layers of the bonded assembly 300 as previously described.

In alternative embodiments, the oversized insulator layer 302 will be diffusion bonded first to the semiconductor layer 304, rather than to the substrate layer 306. After its thickness is reduced, the two (now bonded together) components 304 and 302′ are then bonded to the substrate layer 306. Thinning of the insulator layer 302 after it is bonded to either the substrate layer 306 or to the semiconductor layer 304 may be accomplished by several means, including, but not limited to grinding and/or polishing.

In some alternative embodiments, the SWOI assembly is a two layer assembly comprising only the semiconductor layer 304 and the insulator layer 302, without employing the substrate layer 306. This SWOI assembly may employ an interlayer between the semiconductor layer 304 and insulator layer 302. It may be desirable that the insulator layer 302 be thinned (reduced in thickness) after it is bonded, with or without the use of an interlayer, to the semiconductor layer 304. Thinning of the insulator layer 302 to 302′ after it is bonded to the semiconductor layer 304 may be accomplished by several means, including, but not limited to grinding and/or polishing.

It will be understood that while the examples illustrated herein present the steps of the various process in a particular order, in most cases the order of the steps may be rearranged without departing from the scope of the invention. Thus, unless indicated otherwise, the order of the steps in a particular example should not be considered a limitation to the process disclosed.

The interlayers of the bonded assemblies of the current invention may comprise one or more materials. These materials include, but are not limited to: a glass material; a metal material; a metal alloy material; other electrically conducting materials; a ceramic material; a semiconductor material; and a material comprising a combination of two or more of the previously listed materials. Additionally, the interlayer materials may be coated or plated to promote bonding. Also, the component layer materials may be coated, plated or otherwise pre-processed to promote bonding. Coatings could include, but are not limited to: a glass material; a metal material; a metal alloy material; ceramics; and glass or glasses.

As previously described, solid-state diffusion bonding utilizes a combination of elevated heat and pressure to hermetically bond two surfaces together without first causing one or both of the adjoining surfaces to melt. When making bonded assemblies, it is almost always required that the bonding temperatures remain below some upper limit. For example, in SWOI bonded assemblies, the bonding temperature should be below the glass transition temperature, T_{G}, and the softening temperature, T_{S}, of SWOI components and the interlayers, if employed, so as not to affect the pre-existing physical and electrical characteristics of the component layers. However, the specific temperature and pressure parameters required to produce a hermetic diffusion bond can vary widely depending upon the nature and composition of the two or more mating surfaces being joined. Therefore, it is possible that some combinations of the semiconductor material (e.g., silicon or gallium arsenide) and the insulator material (e.g., glass) will have a diffusion bonding temperature that exceeds the respective T_{G} and/or the T_{S} of one of the materials, or that exceeds some other temperature limit. In such cases, it might appear that diffusion bonding is unsuitable for use in hermetically joining the components together if the temperature limits are to be followed. In fact, however, it has been discovered that the use of interlayers can cause hermetic diffusion bonding to take place at a substantially lower temperature than if the same semiconductor material was bonded directly to the same insulator layer material, or the same insulator material was bonded directly to the same substrate material.

A properly matched interlayer improves the strength and hermeticity (i.e., gas tightness or vacuum tightness) of a diffusion bond. Further, it may promote the formation of compatible joints, produce a monolithic bond at lower bonding temperatures, reduce internal stresses within the bond zone, and prevent the formation of extremely stable oxides which may interfere with diffusion. The interlayer is believed to diffuse into the parent material, thereby raising the melting point of the joint as a whole. Depending upon the materials to be joined by diffusion bonding, the interlayer material could be composed of a metal, a metal alloy, a glass material, a solder glass material including solder glass in tape or sheet form, or other materials. The interlayers are typically formed into thin preforms shaped like the area of the mating surfaces to be joined.

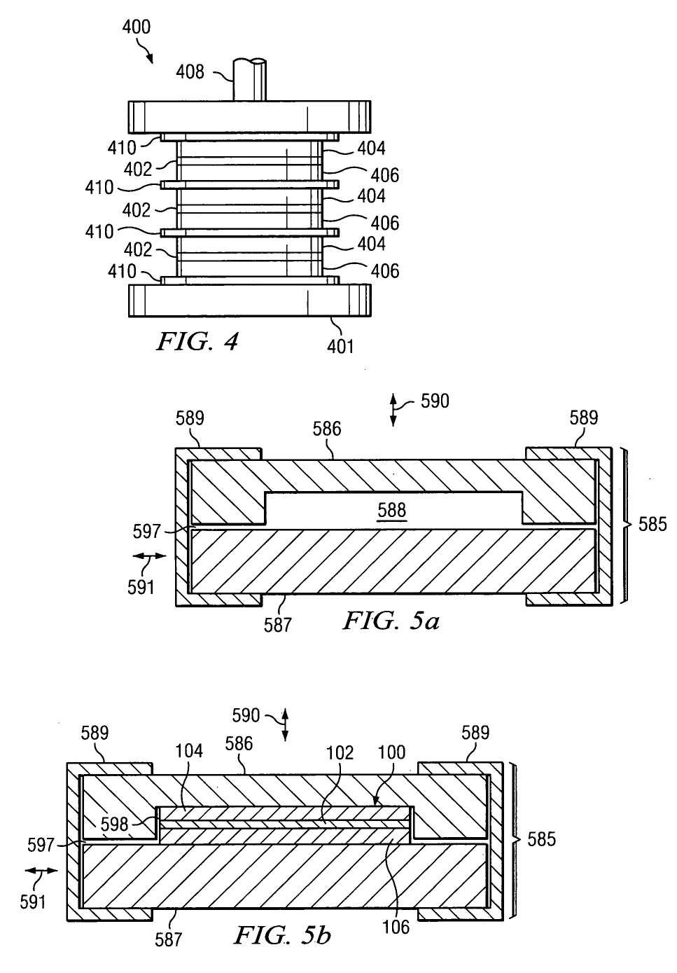

Referring now to FIG. 4, there is illustrated an apparatus for fixturing multiple sets of components for bonded assemblies such as SWOI assemblies for simultaneous diffusion bonding, thereby producing multiple SWOI assemblies simultaneously. The fixture apparatus 400 includes abase 401 upon which are stacked three sets of SWOI assemblies, each composed of a semiconductor layer 404, a glass insulator 402 and a substrate 406, similar to those described in FIGS. 1a and 2a. A hydraulic or pneumatic ram 408 supplies the pressure (i.e., load) against the top of the stack to press the semiconductor, insulator and substrate layers together (against the base) during bonding. Separating the adjacent bonded assemblies (i.e., those belonging to different assemblies) are dividers 410 formed of a material that will not bond to the semiconductors 404, substrates 406, base 401 or ram 408 under the expected bonding conditions. The entire fixture apparatus is disposed inside a diffusion-bonding chamber (not shown). The diffusion-bonding chamber heats the fixture 400 and its stacked components to bonding temperature, and by hydraulic, pneumatic or other means, causes the ram 408 to apply bonding load (pressure) to the stacked components. The bonding temperature and pressure are maintained for the required bonding time necessary to produce a complete hermetic seal between all of the insulators 402 and their respective semiconductors 404 and substrates 406. During the bonding process, the diffusion bonding chamber may be evacuated, pressurized, and/or filled with one or more gases as necessary to promote the bonding of the components. After bonding, the three SWOI assemblies are complete.

The components of the sets of the assemblies do not need to be flat. They may be concave, convex or complex in shape, as long as each component mates intimately with the adjacent component layer, e.g., during the bonding process, the surface of glass (or other insulator material) is in intimate contact with the surface of the semiconductor layer and substrate layer to which it is bonded. Also as previously described, the insulator material for the bonded assemblies need not be glass. It could be a different material, including, but not limited to quartz, sapphire, plastics, polymers and ceramics. It could be a non-hermetic material, but the resulting assembly would then be non-hermetic.

As an alternative to conventional diffusion bonding chambers with internal rams (e.g., as illustrated in FIG. 4), another apparatus that is suitable for diffusion bonding the two or more components together to form the SWOI assemblies is known as a Hot Isostatic Press (“HIP”). A HIP unit provides the simultaneous application of heat and high pressure. In the HIP unit, the work pieces (e.g., the SWOI assembly components) are typically sealed inside a vacuum-tight bag, which is then evacuated. The bag with work pieces inside is then sealed within a pressure containment vessel or apparatus, which in turn is a part of, or is contained within, a high temperature furnace. A gas, typically argon, is introduced into the vessel around the bagged parts and the furnace turned on. As the furnace heats the pressure vessel, the temperature and pressure of the gas inside simultaneously increase. The gas pressure supplies great force pressing the bagged parts together, and the gas temperature supplies the heat necessary to allow bonding to occur. A HIP unit allows the temperature, pressure and process time to all be controlled to achieve the optimum material properties.

As yet another alternative to conventional diffusion bonding chambers, the fixture itself, normally used only to hold the components in position for bonding, may be designed to constrain the expansion of the stacked components during heating (i.e., along the stacking axis), whereby the thermal expansion of the assembly components toward the fixture, and of the fixture itself toward the components, will “self-generate” some or all of the necessary bonding pressures between the components as the temperature increases.

Referring now to FIGS. 5a and 5b, an example of a “self-compressing” fixture assembly is shown. As best seen in FIG. 5a, the fixture 585 includes an upper fixture member 586 and a lower fixture member 587 which together define a cavity 588 for receiving the SWOI assembly components to be bonded. Clamps 589 are provided which constrain the outward movement of the fixture members 586 and 587 in the axial direction (denoted by arrow 590). Generally, the CTE of the material forming the clamps 589 will be lower than the CTE of the material forming the fixture members 586 and 587. FIG. 5b shows the components for a bonded assembly 100 (see FIGS. 1a and 1b), including semiconductor layer 104, insulator layer 102 and substrate layer 106, loaded into the cavity 588 of the fixture 585 in preparation for bonding. Note that while the fixture members 586 and 587 are in contact with the upper and lower surfaces of the assembly's components, a small gap 597 is left between the fixture members themselves to allow the members to expand axially toward one another when heated (since they are constrained by the clamps). Also note that a small gap 598 is generally left between the lateral sides of the SWOI assembly components and the fixture members 586 and 587 to minimize the lateral force exerted on the components by the fixture members during heating.

When the fixture 585 is heated, the inner surfaces (i.e., facing the cavity 588) of the fixture members 586 and 587 will expand (due to thermal expansion) axially toward one another against the assembly components, and the assembly components 102, 104 and 106 will expand outward against the fixture. These thermal expansions can press the assembly components against one another with great force in the axial direction to facilitate diffusion bonding. It will be appreciated that thermal expansion of the fixture members 586 and 587 will also occur in the lateral direction (denoted by arrow 591). While this lateral expansion is not generally desired, in most cases is will not present an obstacle to the use of self-compressing fixtures.

Referring now to FIG. 5c, there is illustrated an alternative self-compressing fixture adapted to enhance thermal expansion (and hence compression) in the axial direction 590 without causing excessive thermal expansion in the lateral direction 591. As with the previous example, alternative fixture 592 includes an upper fixture member 586 and a lower fixture member 587 defining a cavity 588 for receiving the components of the SWOI assembly to be bonded, and clamps 589 (only one of which is shown for purposes of illustration) which constrain the outward movement of the fixture members in the axial direction 590. Also as in the previous embodiment, a first small gap 597 is present between the fixture members 586 and 587 themselves, and a second small gap 598 is present between the lateral sides of the assembly components 102, 104 and 106 (for purposes of illustration, only a portion of the assembly 100 is shown in FIG. 5c) and the fixture members. Unlike the previous embodiment, however, each fixture member 586 and 587 of the alternative fixture 592 comprises two sub-members. Member 586 comprises outer sub-member 593 and inner sub-member 595, while member 587 comprises outer submember 594 and inner sub-member 596. The first (i.e., outer) sub-members 593 and 594, respectively, are adapted primarily to generate the axial force against the assembly components, and the second (i.e., inner) sub-members 595 and 596, respectively, are adapted to hold and align assembly components in the cavity 588. By selecting a material for the first sub-members 593 and 594 having a high CTE, their axial expansion (and hence compression force generated) during heating will be correspondingly high. However, lateral expansion and relative lateral movement between the second sub-members 595 and 596 and the assembly components can be minimized by selecting a different material for the second sub-members, namely, a material having a lower CTE (i.e., lower than the CTE for the first sub-members). Preferably, the CTE of the second sub-members 595 and 596 will be close to the CTE for the adjacent SWOI components.

Preferably, when fabricating bonded assemblies, the coefficient of (linear) thermal expansion (CTE) of the insulator component layer material(s) 102 is matched as well as possible to the CTE of the associated semiconductor layer material 104 and, if used, the substrate layer material 106. The CTE of most glasses is fairly constant from approximately 273° K. (O° C.) up to the softening temperature of the glass. However, some plastics, metals and alloys have very different CTEs at different temperatures. Therefore, the average CTE of the insulator component layer material(s) 102 at the elevated insulator-to-semiconductor layer and insulator-to-substrate layer bonding temperature should be matched as closely as possible to the average CTE of the semiconductor layer 104 and the substrate layer 106 over the same temperature range. The closer the average CTEs of the two materials (insulator and semiconductor if only these two components are used) or three materials (insulator, semiconductor and substrate if these three components are all used), the lower will be the residual stresses in the components after the assembly cools from the elevated bonding temperature back to ambient (room temperature).

Although FIG. 5b and FIG. 5c show the fixture 592 adapted to contain a single assembly 100, the fixture 592 could be designed to accommodate a plurality of assemblies 100 in a similar manner as that illustrated in FIG. 4. In such an instance, each set of components to be bonded together to form a bonded assembly 100 would be separated from each other and the fixture's inner surfaces by employing spacers similar to the spacers 410 shown in FIG. 4. In another alternative, a fixture similar to that illustrated in FIGS. 5b and 5c may be adapted to contain one or more SWOI assemblies composed of only two component members, e.g., semiconductor layer 104 and insulator layer 102.

The long-term reliability (e.g., the ability to resist delamination or other failure) of the components' bonds to their adjacent component layers is affected by the degree of matching of the CTEs of the assemblies' components for the anticipated end-use environment. For example, if the SWOI assembly is expected to be exposed to temperatures from −40° C. to 100° C. (−40° F. to 212° F.), then the component layers 102, 104 and 106 of the final bonded assembly should have closely matched CTEs over this temperature range.

The temperature parameters for diffusion bonding between the mating surfaces of the component layers described above are believed to be within the range from about 40% to about 70% of the absolute melting temperature, in degrees Kelvin, of the parent material having the lower melting temperature. When diffusion bonding is used for bonding glass or other materials that soften at elevated temperatures, the bonding temperature may be selected to be below the T_{G} and/or the softening temperature of the for the glass other softening materials.

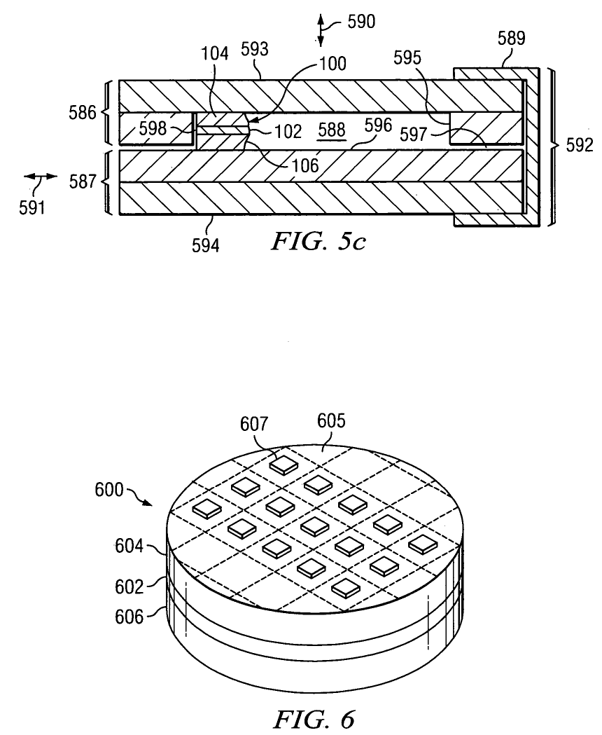

Referring now to FIG. 6, there is illustrated a bonded assembly which is a silicon-on-insulator (SOI) wafer assembly. The SOI wafer assembly 600 comprises three layers, a relatively thick substrate layer 606 of semiconductor material, a relatively thin insulator layer 602 of an electrically insulating layer, and a relatively thin top layer 604 of silicon semiconductor material. The insulator layer 602 is preferably made of an oxide of silicon or glass, while the substrate layer 606 is preferably made of silicon. It will be appreciated that the two upper layers 602 and 604 may be extremely thin, and therefore their thickness is exaggerated in FIG. 6 for purposes of illustration. The three layers 604, 602 and 606 are joined together to form the wafer assembly 600. At least one of the joints between the layers is formed by diffusion bonding. In a preferred embodiment, the remaining joint is also formed by diffusion bonding, but may be formed in a conventional manner in other embodiments.

After the layers have been joined, the SOI wafer assembly 600 may serve as a substrate for the fabrication of one or more semiconductor devices 607 on the upper surface 605 of the silicon top layer 604. After fabrication of the devices, the SOI wafer 600 may be singulated to separate the individual SOI-based devices 607.

It will be understood that interlayers (not shown) may be used as previously described to facilitate diffusion bonding between the layers 604, 602 and 606 of the SOI wafer assembly 600. Also, prior to assembly and bonding, some or all of the layers 604, 602 and 606, and some or all of the interlayers, may require pre-bonding preparation steps. Such pre-bonding preparation operations may include the removal of material and the application of surface treatments and/or coatings to the various layers as previously described.

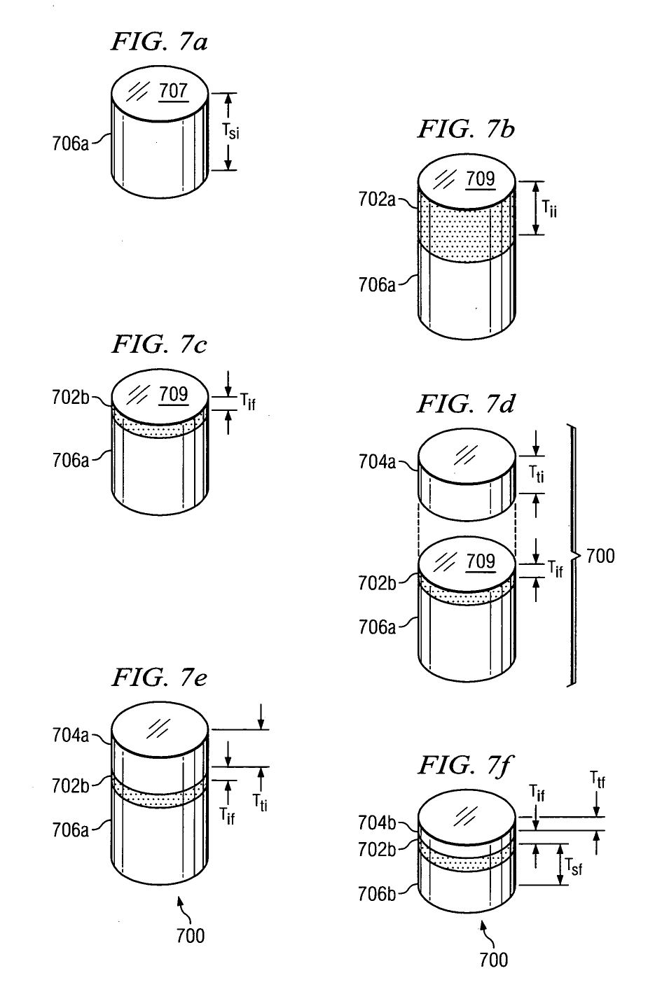

Referring now to FIGS. 7a-7f, there is illustrated the structure and method of fabrication of a bonded SWOI wafer assembly in accordance with yet another embodiment. The SWOI wafer assembly 700 (shown in final form in FIG. 7f) may be a SOI wafer assembly similar to that illustrated in FIG. 6, but it may also be another type of SWOI assembly.

The bonded SWOI wafer assembly 700 comprises the same layers as in previously SWOI assemblies, mainly, a substrate layer 706 (sometimes called a substrate/carrier layer), electrically insulating layer 702 joined to the top of the substrate layer, and a semiconductor top layer 704 joined to the top of the insulator layer. In the process of this embodiment, the various layers may be modified to change their thicknesses, and in such cases the original layer is denoted in FIGS. 7a-7f with the letter “a,” e.g., 702a, 704a and 706a, while the same layer after thickness reduction is denoted with the letter “b,” e.g., 702b, 704b and 706b.

Referring specifically now to FIG. 7a, the original substrate layer 706a is illustrated. The substrate layer 706a is preferably a wafer (thickness is exaggerated in the figures) of silicon or GaAs, but it may be a wafer of another material which is a semiconductor, insulator or conductor. The substrate layer 706a has an initial thickness denoted T_{SI}. Prior to any assembly or bonding, the substrate layer 706a may be subjected to pre-bonding preparation steps such as surface finishing or surface treatment as previously described, to prepare the junction surface 707 or other surfaces of the layer.

Referring specifically now to FIG. 7b, the insulator layer 702a has been joined to the junction surface 707 of the substrate layer 706a. In this embodiment, the insulator layer 702a is preferably a layer of oxide of silicon or glass, but it may be another electrically insulating material. The insulator layer 702a is not joined to the substrate by diffusion bonding as in previous embodiments, but rather is deposited by conventional means (e.g., chemical deposition, CVD, PVD, etc.) or grown in place (e.g., by chemical or thermal conversion of a semiconductor substrate material into an insulating oxide). The insulator layer 702a is deposited/grown until it has an initial thickness denoted by T_{II}. In some cases the initial thickness T_{II} of the insulator layer 702a will be satisfactory for further processing, however, in other embodiments the thickness must be reduced and/or the surface finish of the remaining junction surface 709 must be improved.

Referring specifically now to FIG. 7c, the subassembly comprising the substrate layer 706a and the deposited/grown insulator layer is shown after thinning of the insulator layer (now denoted 702b) to a final thickness denoted by T_{II}. The subassembly may have been processed with pre-bonding surface finish and/or treatment operations as previously described. In particular, the junction surface 709 may need other (optional) surface treatments prior to bonding as previously described. The junction surface 709 should now have the required surface characteristics for diffusion bonding to the semiconductor top layer.

Referring specifically now to FIG. 7d, the semiconductor top layer 704a is shown ready for diffusion bonding to the junction surface 709 of the already joined and thinned (if applicable in this case) subassembly comprised of layers 706a and 702b. As indicated above, diffusion bonding is used to join the semiconductor top layer 704a to the junction surface 709 of the subassembly. The semiconductor top layer 704a has an initial thickness denoted by TTI, and may have been processed with pre-bonding surface finish and/or treatment operations as previously described.

Referring specifically now to FIG. 7e, the SWOI assembly 700 is shown immediately following diffusion bonding of the top semiconductor layer 704a to the thinned insulator layer 702b. The diffusion bonding operation may be performed using any of the diffusion bonding procedures previously described. In some embodiments, the post-bonding thickness of the semiconductor top layer 702a and the substrate layer 706a are acceptable, and the assembly 700 may be considered complete and ready for post-bonding processing. In other embodiments, further thinning may be required.

Referring specifically now to FIG. 7f, the SWOI assembly 700 is shown after optional thinning operations performed on the top semiconductor layer (now denoted 704b) to a final thickness denoted T_{TF}, and/or on the substrate layer (now denoted 706b) to a final thickness denoted T_{SF}. It will be appreciated that all of the thinning procedures of this embodiment may be accomplished using conventional means including, but not limited to, grinding and/or polishing. Following any thinning operations, the SWOI assembly 700 may be considered complete and ready for any final processing.

It will be appreciated that the embodiment just described may also be “inverted” in a number of ways, e.g., the substrate layer 706 may be grown or deposited on the insulator layer 702 to form the sub-assembly of FIGS. 7b and 7c, or alternatively, the insulator layer 702 may be grown or deposited on the semiconductor layer 704, or vice versa, to form a first sub-assembly, which in turn is diffusion bonded to the substrate layer 706, without departing from the scope of the current invention.

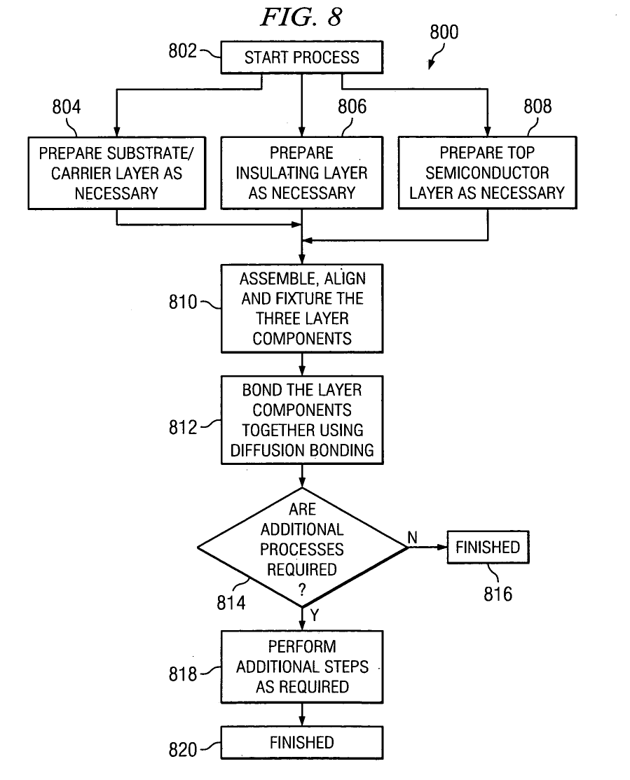

Referring now to FIG. 8, there is shown a simplified block diagram of the process flow for manufacturing bonded assemblies using diffusion bonding. Each of the steps in the process 800 has been previously described herein, and therefore will not be described in detail again. The process start is denoted by block 802. Next, each of the substrate/carrier layer, insulator layer and top semiconductor layer is prepared using pre-bonding preparation steps, as denoted by blocks 804, 806 and 808, respectively. As indicated in the figure, this preparation of the various layers (blocks 804, 806 and 808) may be accomplished in any order. Once each of the layers has been prepared, the three layer components are assembled, aligned and fixtured in preparation for diffusion bonding as indicated by block 810. Next, as indicated by block 812, the components are bonded together using diffusion bonding. It will be appreciated that in some embodiments, the fixturing and bonding operations represented by blocks 810 and 812, respectively, may be performed on all three layers at once to form all diffusion bonds simultaneously. In other embodiments, the fixturing and bonding operations of blocks 810 and 812 may be performed a first time on two layers to create a first diffusion bond, and then a second time on the remaining two layers to form the second diffusion bond.

Once the diffusion bonding of the layers is completed, it must be determined if post-bonding additional processes are required as indicated in block 814. If no additional processes are required, the bonded assembly is considered finished as indicated by block 816. If, on the other hand, additional processing steps are required, such as material removal or surface treatments, then the post-bonding operations are performed as indicated by block 818. Following completion of any post-bonding operations, the bonded assembly is considered finished as indicated by block 820.

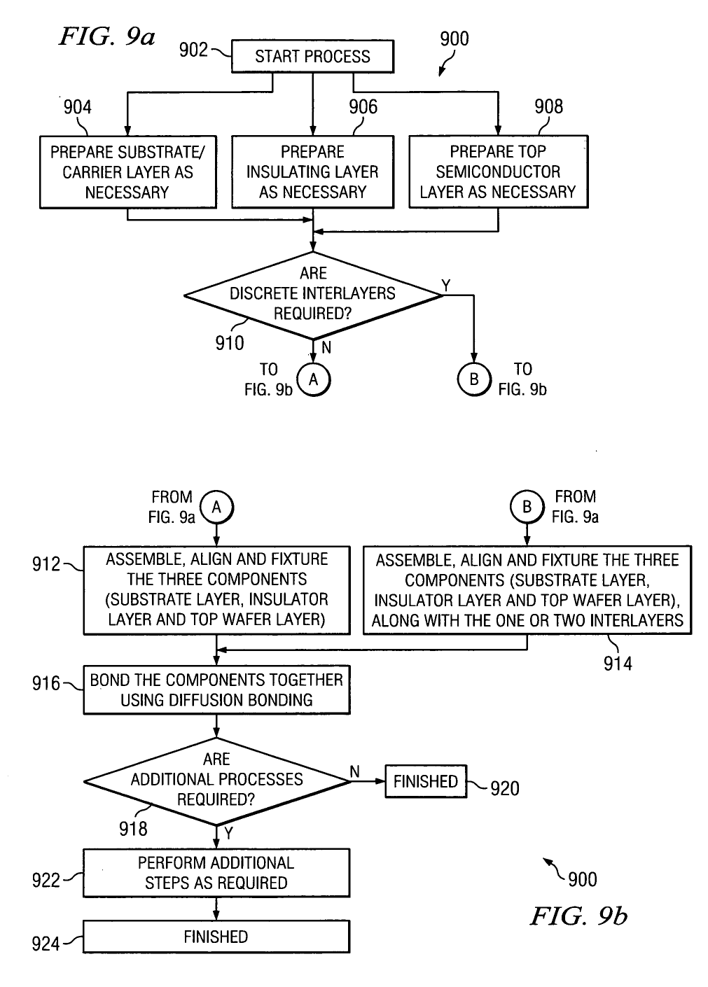

Referring now to FIGS. 9a and 9b, there is shown a more detailed block diagram of the process flow for manufacturing bonded assemblies using diffusion bonding. The manufacturing process 900 begins in block 902. Next, each of the substrate layer, insulator layer and top semiconductor layer are prepared as necessary, as indicated in blocks 904, 906 and 908, respectively. As in the previous embodiment, the previous three steps (blocks 904, 906 and 908) may be completed in any order. After the layers are completed, it must be determined whether discreet interlayers will be required as shown in block 910. If discreet interlayers are not required, the process continues (through connector “A”) to process block 912 where the component layers are assembled, aligned and fixtured in preparation for bonding. If the process block 910 determines that discreet interlayers are required, however, the process branches (through connector “B”) to an alternative block 914, wherein the three layer components (substrate layer, insulator layer and top semiconductor layer) are assembled, aligned, and fixtured along with the one or two interlayers required for bonding. Once the necessary components have been fixtured as indicated by block 912 or 914 (as appropriate), the process flow continues to block 916 where the components are bonded together using diffusion bonding as previously described. As described in connection with blocks 810 and 812 of FIG. 8, the diffusion bonding process may form all bonds simultaneously, or it may form them in a sequence of bonding operations.

After diffusing bonding is complete, the process continues to block 918 where it is determined whether additional post-bonding processes are required. If no such post-bonding processes are required, then the bonded assemblies may be considered finished as indicated by block 920. If, on the other hand, additional post-bonding processing steps are required, then the process branches to block 922 wherein the post-bonding operations, e.g., material removal, surface finishing or coating steps, are performed as required. Once the post-bonding processing steps are completed, the bonded assembly is considered finished as indicated by block 924.

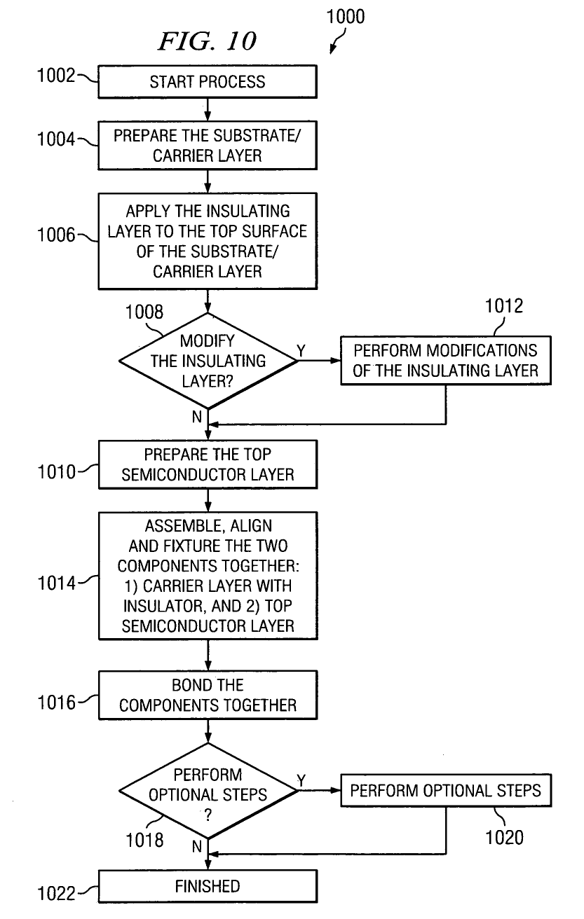

Referring now to FIG. 10, there is shown a block diagram of an alternative embodiment process flow for manufacturing bonded assemblies which utilizes both diffusion bonding and the conventional growth or deposition of material to join the layers of the bonded assembly as previously described in connection with FIGS. 7a-7f. The process 1000 begins in block 1002. Next, the substrate/carrier layer is prepared using the pre-bonding operations previously described as indicated by block 1004. Next, the insulator layer is joined or applied to the top surface of the substrate/carrier layer as shown by block 1006. This application may be performed by conventional means such as chemical deposition or growth rather than by diffusion bonding. After the insulator layer has been applied to the top surface of the substrate layer, it must be determined whether the insulator layer requires further modification as indicated by block 1008. If no modification to the insulator layer is required, then the process continues to block 1010 for pre-bonding preparation of the top semiconductor layer. If, on the other hand, the insulator layer does require thinning or other modification, the pre-bonding modifications are performed as indicated in block 1012, and then the process proceeds to preparation of the top semiconductor layer (block 1010). After the top semiconductor layer has been prepared for diffusion bonding (block 1010), the operation proceeds to block 1014 wherein the remaining two components (i.e., the substrate layer and insulator layer subassembly, and the top semiconductor layer) are assembled, aligned and fixtured in preparation for diffusion bonding. If indicated, interlayers may be used to facilitate the diffusion bonding process. The interlayers may be inserted between the layers in block 1014 or formed on one of the layers during earlier processing (e.g., blocks 1010 or 1012).

After fixturing is complete, the substrate layer and insulator layer subassembly is diffusion bonded to the top semiconductor layer as indicated in block 1016. Following bonding, it must be determined if post-bonding operations are required as indicated in block 1018. If these optional post-bonding operations are required, the process proceeds to block 1020, wherein the optional post-bonding procedures are carried out. These procedures may include additional thinning of the substrate layer and/or of the semiconductor top layer. These procedures may also include surface finishes or surface treatments on the exterior surfaces of the assembly. After any optional post-bonding steps have been completed, (or if no post-bonding steps were required) the bonded assembly may be considered finished and the process is completed as indicated by block 1022. It will be appreciated that the process just described may be “inverted” (e.g., the insulator layer applied to the top semiconductor layer rather than to the substrate layer) or otherwise reordered as previously described without departing from the scope of the current invention.

While the invention has been shown or described in a variety of its forms, it should be apparent to those skilled in the art that it is not limited to these embodiments, but is susceptible to various changes without departing from the scope of the invention.

1. A process for manufacturing bonded assemblies, the process comprising the following steps:
providing a first lamina formed of a substrate material that is one of an electrical conductor, a semiconductor and an electrical insulator;
superposing a second lamina formed of an electrically insulating material on top of the first lamina to define a first junction region where the first and second laminae contact one another;
superposing a third lamina formed of a semiconductor material on top of the second lamina to define a second junction region where the second and third laminae contact one another;
pressing the first and second laminae together with sufficient force to produce a first predetermined contact pressure between the first and second laminae along the first junction region;
heating the first junction region to produce a first predetermined temperature along the first junction region;
maintaining the first predetermined contact pressure and the first predetermined temperature until a first diffusion bond is formed between the first and second laminae all along the first junction region;
pressing the second and third laminae together with sufficient force to produce a second predetermined contact pressure between the second and third laminae along the second junction region;
heating the second junction region to produce a second predetermined temperature along the second junction region; and
maintaining the second predetermined contact pressure and the second predetermined temperature until a second diffusion bond is formed between the second and third laminae all along the second junction region.

2. A process in accordance with claim 1, wherein the step of pressing the first and second laminae together to produce the first predetermined contact pressure along the first junction region is performed simultaneously with the step of pressing the second and third laminae together to produce the second predetermined contact pressure along the second junction region.

3. A process in accordance with claim 1, wherein the step of pressing the first and second laminae together to produce the first predetermined contact pressure along the first junction region, and the step of pressing the second and third laminae together to produce the second predetermined contact pressure along the second junction region are not performed simultaneously.

4. A process in accordance with claim 3, further comprising the following steps: thinning the second, insulating lamina from an original thickness to a reduced thickness after one of the first and second diffusion bonds has been formed, but before the other of the first and second diffusion bonds has been formed.

5. A process in accordance with claim 1, wherein the semiconductor material of the third lamina is silicon.

6. A process in accordance with claim 5, wherein the substrate material of the first lamina is silicon.

7. A process in accordance with claim 1, wherein the semiconductor material of the third lamina is GaAs.

8. A process for manufacturing bonded assemblies, the process comprising the following steps:
providing a first layer formed of an electrically insulating material;
superposing a second layer formed of a semiconductor material on top of the first layer to define a junction region where the first and second layers contact one another;
pressing the first and second layers together with sufficient force to produce a predetermined contact pressure between the first and second layers along the junction region;
heating the junction region to produce a predetermined temperature along the junction region; and
maintaining the predetermined contact pressure and the predetermined temperature until a diffusion bond is formed between the first and second layers along the junction region.

9. A process in accordance with claim 8, further comprising the following steps: thinning the first insulating layer from an original thickness to a reduced thickness after the diffusion bond has been formed.

10. A process in accordance with claim 9, wherein the step of thinning the insulating layer is performed by a grinding operation.

11. A process in accordance with claim 9, wherein the step of thinning the insulating layer is performed by a polishing operation.

12. A process for manufacturing bonded assemblies, the process comprising the following steps:
providing a first lamina formed of a substrate material that is one of an electrical conductor, a semiconductor and an electrical insulator;
providing a second lamina formed of an electrically insulating material disposed near the first lamina;
providing a first interlayer interposed between the first and second laminae, the first interlayer formed of a material dissimilar to the materials of the first and second laminae;
pressing the first and second laminae against the first interlayer with sufficient force to produce a first predetermined contact pressure between the first lamina and the first interlayer and between the second lamina and the first interlayer;
heating a region surrounding the first interlayer to produce a first predetermined temperature in the region surrounding the first interlayer;
maintaining the first predetermined contact pressure and an elevated temperature in the region surrounding the first interlayer until diffusion bonds are formed between the first lamina and the second lamina;
providing a third lamina formed of a semiconductor material disposed near the insulating lamina;
providing a second interlayer interposed between the second and third laminae, the second interlayer formed of a material dissimilar to the materials of the second and third laminae;
pressing the second and third laminae against the second interlayer with sufficient force to produce a second predetermined contact pressure between the second lamina and the second interlayer and between the third lamina and the second interlayer;
heating a region surrounding the second interlayer to produce a second predetermined temperature in the region surrounding the second interlayer; and
maintaining the second predetermined contact pressure and an elevated temperature in the region surrounding the second interlayer until diffusion bonds are formed between the second lamina and the third lamina.

13. A process in accordance with claim 12, wherein the diffusion bonds formed between the first lamina and the second lamina include a diffusion bond of the first lamina to the first interlayer and a diffusion bond of the first interlayer to the second lamina.

14. A process in accordance with claim 12, wherein the diffusion bonds formed between the first lamina and the second lamina include a diffusion bond of the first lamina to the second lamina.

15. A process in accordance with claim 12, wherein the substrate material of the first lamina is silicon, the insulating material of the second lamina is silicon dioxide, and the semiconductor material of the third lamina is silicon.

16. A process for manufacturing bonded assemblies, the process comprising the following steps:
providing a first layer formed of a substrate material that is one of an electrical conductor, a semiconductor and an electrical insulator, the first layer having a top surface and an initial thickness;
forming a second layer of an electrically insulating material on the top surface of the first layer, the second layer having a top surface and an initial thickness after forming;
providing a third layer formed of a semiconductor material disposed near the top surface of the second layer, the third layer having a top layer and an initial thickness;
pressing the third layer against the top surface of the second layer with sufficient force to produce a predetermined contact pressure along a junction region between the second and third layers;
heating the junction region to produce a predetermined initial temperature in the junction region; and
maintaining the predetermined contact pressure and an elevated temperature in the junction region until a diffusion bond forms between the second and third layers.

17. A process in accordance with claim 16, wherein the step of forming the second layer is performed using one of chemical deposition, chemical vapor deposition, plasma vapor deposition, growth by chemical conversion of the first layer and growth by thermal conversion of the first layer.

18. A process in accordance with claim 16, further comprising the step of: reducing the thickness of the second layer from the initial thickness to a final thickness by removing material from the top surface of the second layer after forming the second layer on the first layer, but prior to pressing the third layer against the top surface of the second layer.

19. A process in accordance with claim 18, further comprising the step of: reducing the thickness of the third layer from the initial thickness to a final thickness by removing material from the top surface of the third layer after diffusion bonding to the second layer.

20. A process in accordance with claim 19, wherein the substrate material of the first layer is silicon, the insulating material of the second layer is silicon dioxide, and the semiconductor material of the third layer is silicon.

21. A process in accordance with claim 16, wherein the elevated temperature maintained in the junction region is substantially equal to the predetermined initial temperature.

22. A process in accordance with claim 16, wherein the elevated temperature maintained in the junction region is less than the predetermined initial temperature, but sufficient to allow diffusion of material between the second and third layers.

23. A process in accordance with claim 16, further comprising the steps of: providing an interlayer interposed between the second and third layers prior to bonding, the interlayer formed of a material dissimilar to the materials of the second and third layers.
